(19) United States
(12) Patent Application Publication
(10) Pub. No.: US 2015/0103255 A1
(43) Pub. Date: Apr. 16, 2015

(54) APPARATUS AND METHOD FOR SEARCHING BROADCAST CHANNELS

(71) Applicant: SAMSUNG ELECTRO-MECHANICS CO., LTD., Suwon-Si (KR)

(72) Inventors: Nam Min KIM, Suwon-Si (KR); Hyung Bong JEON, Suwon-Si (KR); Ju Ho LEE, Suwon-Si (KR); Si Young KWON, Suwon-Si (KR); Dong Jin YOON, Suwon-Si (KR); Kyo Sang LEE, Suwon-Si (KR); In Jong JANG, Suwon-Si (KR); Tae Gyu RYU, Suwon-Si (KR); Jae Soon LEE, Suwon-Si (KR)

(73) Assignee: SAMSUNG ELECTRO-MECHANICS CO., LTD., Suwon-Si (KR)

(21) Appl. No.: 14/281,426

(22) Filed: May 19, 2014

(30) Foreign Application Priority Data
Oct. 14, 2013 (KR) 10-2013-0121972

(51) Int. Cl. H04N 5/50; H04N 5/46; H04N 21/426; H04N 5/44; H04N 21/438

(52) U.S. Cl. CPC H04N 5/50; H04N 5/4401; H04N 21/4383; H04N 21/4263; H04N 5/46
USPC 348/732

(57) ABSTRACT

An apparatus for searching broadcast channels may include a broadcast signal distributing unit distributing a broadcast signal, a first channel searching unit searching an analog broadcast channel in the distributed broadcast signal, a second channel searching unit searching a digital broadcast channel in the distributed broadcast signal, and a controlling unit receiving search results from the first channel searching unit and the second channel searching unit, generating effective channel information regarding the analog broadcast channel and the digital broadcast channel using the received search results, and controlling the second channel searching unit to skip a channel search in a frequency band in which the analog broadcast channel is present using the generated effective channel information regarding the analog broadcast channel when the search for the analog broadcast channel by the first channel searching unit is terminated first.

### CROSS-REFERENCE TO RELATED APPLICATIONS

This application claims the priority of Korean Patent Application No. 10-2013-0121972 filed on Oct. 14, 2013, in the Korean Intellectual Property Office, the disclosure of which is incorporated herein by reference.

### BACKGROUND

The present disclosure relates to an apparatus and a method for searching broadcast channels.

In general, broadcast receiving apparatuses such as televisions, set-top boxes, and the like include an auto scan function searching for effective broadcast channels among a plurality of broadcast channels from a broadcast signal received via an antenna and configuring a channel list using information regarding searched effective channels to store the channel list in a memory. A channel list stored as described above is used when controlling subsequent channel related operations.

As terrestrial broadcasting, satellite broadcasting, cable broadcasting, and the like are digitalized, the number of available channels is increased by several tens to several hundreds of times as compared to that of analog broadcasting. Therefore, a broadcast receiving apparatus receiving an analog broadcast signal as well as a digital broadcast signal requires a significant amount of time to perform a channel searching operation.

According to the related art, since the channel searching operation is performed for all the analog and digital broadcast channels when performing the channel searching operation to thereby generate effective channel information for both analog and digital broadcasts, a large amount of time may be spent in searching channels.

### SUMMARY

An exemplary embodiment in the present disclosure may provide an apparatus and a method for searching broadcast channels, capable of reducing a channel searching time by skipping a search of a digital broadcast channel using analog broadcast channel information while searching an analog broadcast channel and the digital broadcast channel using a plurality of broadcast searching units.

According to an exemplary embodiment in the present disclosure, an apparatus for searching broadcast channels may include: a broadcast signal distributing unit distributing a broadcast signal; a first channel searching unit searching an analog broadcast channel in the distributed broadcast signal; a second channel searching unit searching a digital broadcast channel in the distributed broadcast signal; and a controlling unit receiving search results from the first channel searching unit and the second channel searching unit, generating effective channel information regarding the analog broadcast channel and the digital broadcast channel using the received search results, and controlling the second channel searching unit to skip a channel search in a frequency band in which the analog broadcast channel is present using the generated effective channel information regarding the analog broadcast channel when the search for the analog broadcast channel by the first channel searching unit is terminated first.

The first channel searching unit may include: a tuner unit generating an intermediate frequency signal for each preset frequency band in the broadcast signal, and a demodulating unit demodulating the intermediate frequency signal and outputting channel information.

The second channel searching unit may include: a tuner unit generating an intermediate frequency signal for each preset frequency band in the broadcast signal, and a demodulating unit demodulating the intermediate frequency signal and outputting channel information.

The first channel searching unit may search the analog broadcast channel or the digital broadcast channel.

The controlling unit may control the second channel searching unit to search the digital broadcast channel in the broadcast signal in a first direction, and may control the first channel searching unit to search the digital broadcast channel in the broadcast signal in a second direction when the search for the analog broadcast channel by the first channel searching unit is terminated earlier than the search for the digital broadcast channel by the second channel searching unit.

According to an exemplary embodiment in the present disclosure, an apparatus for searching broadcast channels may include: a broadcast signal distributing unit distributing a broadcast signal; a plurality of analog/digital channel searching units searching an analog broadcast channel or a digital broadcast channel in the distributed broadcast signal; a plurality of digital channel searching units searching a digital broadcast channel in the distributed broadcast signal; and a controlling unit receiving search results from the analog/digital channel searching unit and the digital channel searching unit, generating effective channel information regarding the analog broadcast channel and the digital broadcast channel using the received search results, and controlling the digital channel searching unit to skip a channel search in a frequency band in which the analog broadcast channel is present using the generated effective channel information regarding the analog broadcast channel when the search for the analog broadcast channel by the analog/digital channel searching unit is terminated first.

The analog/digital channel searching unit may include a first analog/digital channel searching unit and a second analog/digital searching unit, and the controlling unit may control the first analog/digital channel searching unit to search the analog broadcast channel in the broadcast signal in a first direction and control the second analog/digital channel searching unit to search the analog broadcast channel in the broadcast signal in a second direction.

The digital channel searching unit may include a first digital channel searching unit and a second digital channel searching unit, and the controlling unit may control the first digital channel searching unit and the second digital channel searching unit to sequentially search the digital broadcast channel in the broadcast signal in a first direction and control the first analog/digital channel searching unit and the second analog/digital channel searching unit to sequentially search the digital broadcast channel in the broadcast signal in a second direction when the search for the analog broadcast channel by the analog/digital channel searching unit is terminated first.

According to an exemplary embodiment in the present disclosure, a method for searching broadcast channels may include: distributing a broadcast signal; searching an analog broadcast channel and a digital broadcast channel in the distributed broadcast signal; generating effective channel information regarding the analog broadcast channel when the search for the analog broadcast channel is terminated first; applying the generated effective channel information regarding the analog broadcast channel to the search for the digital broadcast channel; and generating effective channel information regarding the digital broadcast channel.

The searching of the analog broadcast channel and the digital broadcast channel may include: generating a central frequency signal in a preset frequency band in the distributed broadcast signal; and demodulating the generated central frequency signal and outputting channel information.

The applying of the generated effective channel information regarding the analog broadcast channel to the search for the digital broadcast channel may include: determining whether or not the analog broadcast channel is present in a frequency band in which the digital broadcast channel is currently searched using the effective channel information regarding the analog broadcast channel; and skipping the search for the digital broadcast channel in the frequency band when the analog broadcast channel is present in the frequency band.

The applying of the generated effective channel information regarding the analog broadcast channel to the search for the digital broadcast channel may include: searching the digital broadcast channel in the frequency band when the analog broadcast channel is not present in the frequency band. The method may further include, when the frequency band is not a final frequency band for the broadcast signal, proceeding to the next frequency band and determining whether or not the analog broadcast channel is present therein.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a configuration diagram illustrating an apparatus for searching broadcast channels according to an exemplary embodiment of the present disclosure;

FIG. 2 is a configuration diagram illustrating an example of a first channel searching unit and a second channel searching unit of FIG. 1;

FIG. 3 is a diagram illustrating an example of broadcast channel search directions of the first channel searching unit and the second channel searching unit of FIG. 1;

FIG. 4 is a configuration diagram illustrating an apparatus for searching broadcast channels according to an exemplary embodiment of the present disclosure;

FIG. 5 is a diagram illustrating an example of search directions of an analog/digital channel searching unit and a digital channel searching unit of FIG. 4;

FIG. 6 is a diagram illustrating another example of search directions of the analog/digital channel searching unit and the digital channel searching unit of FIG. 4;

FIG. 7 is a flow chart illustrating an example of a method for searching broadcast channels according to an exemplary embodiment of the present disclosure;

FIG. 8 is a flow chart illustrating an example of an operation of searching an analog broadcast channel and a digital broadcast channel of FIG. 7; and

FIG. 9 is a flow chart illustrating an example of an operation of applying effective channel information regarding an analog broadcast channel of FIG. 7 to the searching of the digital broadcast channel.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

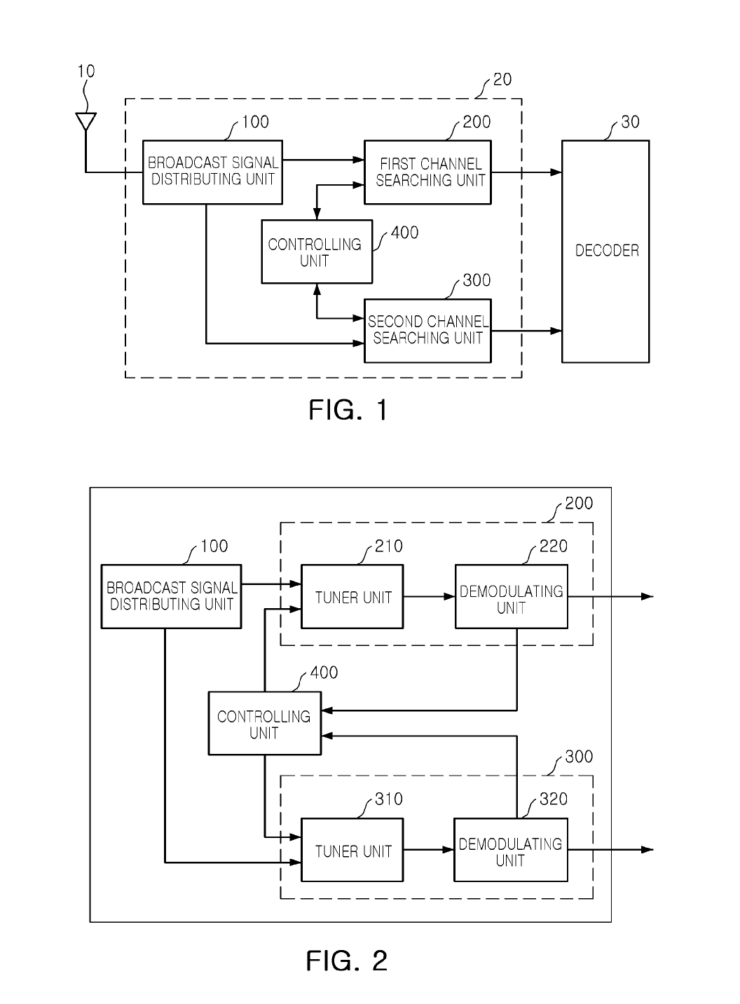

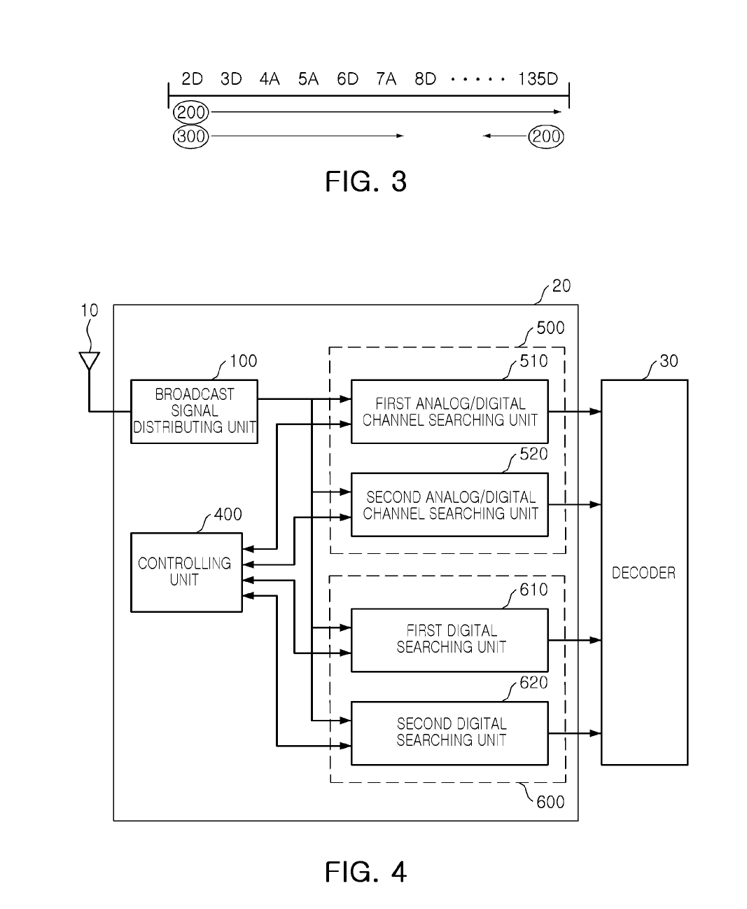

FIG. 1 is a configuration diagram illustrating an apparatus for searching broadcast channels according to an exemplary embodiment of the present disclosure. FIG. 2 is a configuration diagram illustrating an example of a first channel searching unit and a second channel searching unit of FIG. 1. FIG. 3 is a diagram illustrating an example of broadcast channel search directions of the first channel searching unit and the second channel searching unit of FIG. 1.

Referring to FIGS. 1 and 2, an apparatus 20 for searching broadcast channels according to an exemplary embodiment of the present disclosure may include a broadcast signal distributing unit 100 distributing a broadcast signal received from an antenna 10, a first channel searching unit 200 searching an analog broadcast channel in the distributed broadcast signal, a second channel searching unit 300 searching a digital broadcast channel in the distributed broadcast signal, and a controlling unit 400 controlling a channel searching operation of the first channel searching unit 200 and the second channel searching unit 300.

The broadcast signal distributing unit 100 may distribute the broadcast signal received from the antenna 10 to the first channel searching unit 200 and the second channel searching unit 300. Here, the broadcast signal distributing unit 100 may further include an amplifying unit (not shown) amplifying the broadcast signal which is distributed to the first channel searching unit 200 and the second channel searching unit 300.

The first channel searching unit 200 may search an analog broadcast channel in the broadcast signal distributed from the broadcast signal distributing unit 100. According to an exemplary embodiment of the present disclosure, the first channel searching unit 200 may search the analog broadcast channel or the digital broadcast channel. In addition, the second channel searching unit 300 may search the digital broadcast channel in the broadcast signal distributed from the broadcast signal distributing unit 100.

According to an exemplary embodiment of the present disclosure, the first channel searching unit 200 and the second channel searching unit 300 may include tuner units 210 and 310 and demodulating units 220 and 320.

By way of example, the tuner units 210 and 310 may generate a central frequency signal in each preset frequency band in the broadcast signal distributed from the broadcast signal distributing unit 100.

The demodulating units 220 and 320 may demodulate the central frequency signal generated from the tuner units 210 and 310. Here, the demodulated central frequency signal may include broadcast channel information, image information, and voice information of the corresponding frequency band.

The demodulating units 220 and 320 may output the image information and the voice information to a decoder 30 and may output the broadcast channel information to the controlling unit 400.

The controlling unit 400 may control the broadcast channel searching operation of the first channel searching unit 200 and the second channel searching unit 300 and receive the broadcast channel information from the first channel searching unit 200 and the second channel searching unit 300 to thereby generate effective broadcast channel information.

By way of example, the controlling unit 400 may control the first channel searching unit 200 to search the analog broadcast channel in the broadcast signal. At the same time, the controlling unit 400 may control the second channel searching unit 300 to search the digital broadcast channel in the broadcast signal.

That is, the controlling unit 400 may control the first channel searching unit 200 and the second channel searching unit 300 to simultaneously search the analog broadcast channel and the digital broadcast channel.

Here, in a case in which the search for analog broadcast channel by the first channel searching unit 200 is terminated first, the controlling unit 400 may generate effective channel information regarding the analog broadcast channel based on the broadcast channel information received from the demodulating unit 220 of the first channel searching unit 200. Here, the controlling unit 400 may generate the effective channel information regarding the analog broadcast channel in a list form including the broadcast channel information.

When the second channel searching unit 300 searches the digital broadcast channel using the effective channel information regarding the analog broadcast channel, the controlling unit 400 may control the second channel searching unit 300 to skip the search of a frequency band in which the analog broadcast channel is searched.

According to an exemplary embodiment of the present disclosure, as shown in FIG. 3, the controlling unit 400 may control the first channel searching unit 200, which first terminates the search for the analog broadcast channel, to search the digital broadcast channel.

By way of example, the controlling unit 400 may control the first channel searching unit 200 and the second channel searching unit 300 to first search the analog broadcast channel and the digital broadcast channel in a first direction. Here, when the search for analog broadcast channel by the first channel searching unit 200 is terminated first, the controlling unit 400 may control the first channel searching unit 200 to search the digital broadcast channel in a second direction.

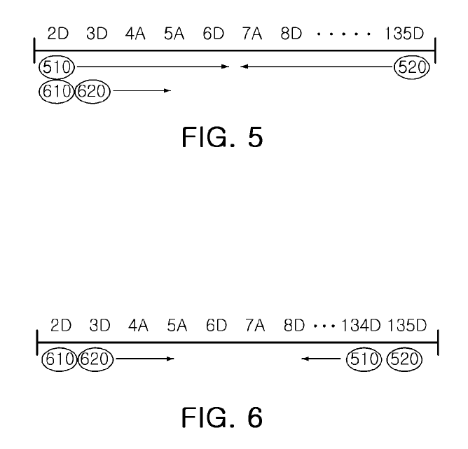

FIG. 4 is a configuration diagram illustrating an apparatus for searching broadcast channels according to an exemplary embodiment of the present disclosure. FIG. 5 is a diagram illustrating an example of search directions of an analog/digital channel searching unit and a digital channel searching unit of FIG. 4. FIG. 6 is a diagram illustrating another example of search directions of the analog/digital channel searching unit and the digital channel searching unit of FIG. 4.

Referring to FIG. 4, an apparatus for searching broadcast channels according to an exemplary embodiment of the present disclosure may include the broadcast signal distributing unit 100, an analog/digital channel searching unit 500, a digital channel searching unit 600, and the controlling unit 400.

The broadcast signal distributing unit 100 may distribute the broadcast signal received from the antenna 10 to an analog/digital channel searching unit 500 and a digital channel searching unit 600. Here, the broadcast signal distributing unit 100 may further include an amplifying unit (not shown) amplifying the broadcast signal distributed to the analog/digital channel searching unit 500 and the digital channel searching unit 600.

The analog/digital channel searching unit 500 may serve to search an analog broadcast channel or a digital broadcast channel in the broadcast signal distributed from the broadcast signal distributing unit 100 and may include a plurality of analog/digital channel searching units 510 and 520.

According to an exemplary embodiment of the present disclosure, the analog/digital channel searching unit 500 may include a first analog/digital channel searching unit 510 and a second analog/digital channel searching unit 520.

The digital channel searching unit 600 may serve to search the digital broadcast channel in the broadcast signal distributed from the broadcast signal distributing unit 100 and may include a plurality of digital channel searching units 610 and 620.

According to an exemplary embodiment of the present disclosure, the digital channel searching unit 600 may include a first digital channel searching unit 610 and a second digital channel searching unit 620.

Here, the analog/digital channel searching unit 500 and the digital channel searching unit 600 may serve to search broadcast channel information included in the broadcast signal distributed in each preset frequency band, and searching operations and searching directions of the plurality of analog/digital channel searching units 510 and 520 and the plurality of digital channel searching units 610 and 620 may be adjusted by the controlling unit 400.

In addition, each of the plurality of analog/digital channel searching units 510 and 520 and the plurality of digital channel searching units 610 and 620 may include the tuner unit 210 and the demodulating unit 220.

The controlling unit 400 may control operations of the analog/digital channel searching unit 500 and the digital channel searching unit 600, receive the broadcast channel search results from the analog/digital channel searching unit 500 and the digital channel searching unit 600, and generate effective channel information regarding the analog broadcast channel and the digital broadcast channel using the received search results.

In addition, when the search for the analog broadcast channel by the analog/digital channel searching unit 500 is terminated first, the controlling unit 400 may control the digital channel searching unit 600 to skip a channel search in a frequency band in which the analog broadcast channel is present, at the time of searching the digital broadcast channel using the effective channel information regarding the analog broadcast channel.

The controlling unit 400 may control the broadcast channel search directions of the plurality of analog/digital channel searching units 510 and 520 or the plurality of digital channel searching units 610 and 620.

According to an exemplary embodiment of the present disclosure, as shown in FIG. 5, the controlling unit 400 may control the first analog/digital channel searching unit 510 to search the analog broadcast channel in a first direction and control the second analog/digital channel searching unit 520 to search the analog broadcast channel in a second direction. In addition, the controlling unit 400 may control the first digital channel searching unit 610 and the second digital channel searching unit 620 to sequentially search the digital broadcast channel in the first direction.

According to an exemplary embodiment of the present disclosure, when the search for the analog broadcast channel by the plurality of analog/digital channel searching units 510 and 520 is terminated earlier than the search for the digital broadcast channel by the plurality of digital channel searching units 610 and 620, the controlling unit 400 may control the plurality of analog/digital channel searching units 510 and 520 to search the digital broadcast channel.

Referring to FIG. 6, the controlling unit 400 may control the first and second analog/digital channel searching units 510 and 520 that have terminated the search for the analog broadcast channel, to search the digital channel from an opposite end of a start point at which the first and second digital channel searching units 610 and 620 search the digital channel in the second direction opposite to the first direction.

Here, the controlling unit 400 may generate the effective broadcast channel information regarding the analog broadcast channel using the searching result of the analog broadcast channel and may more rapidly complete the search for the digital broadcast channel using the generated effective broadcast channel information regarding the analog broadcast channel.

That is, as in an exemplary embodiment of the present disclosure described above, when the first and second digital channel searching units 610 and 620 and the first and second analog/digital channel searching units 510 and 520 search the digital broadcast channel using the effective broadcast channel information regarding the analog broadcast channel, the controlling unit 400 may allow the first and second digital channel searching units 610 and 620 and the first and second analog/digital channel searching units 510 and 520 to rapidly perform the search for the digital broadcast channel by controlling the first and second digital channel searching units 610 and 620 and the first and second analog/digital channel searching units 510 and 520 to skip the search for the digital broadcast channel in the frequency band in which the analog broadcast channel is searched.

In addition, when the search for the channels is completed at a point in which one of the first and second analog/digital channel searching units 510 and 520 and one of the first and second digital channel searching units 610 and 620 are adjacent to each other, the controlling unit 400 may terminate the search for the channels and may generate the effective broadcast channel information using the channel search results received from the first and second analog/digital channel searching units 510 and 520 and the first and second digital channel searching units 610 and 620.

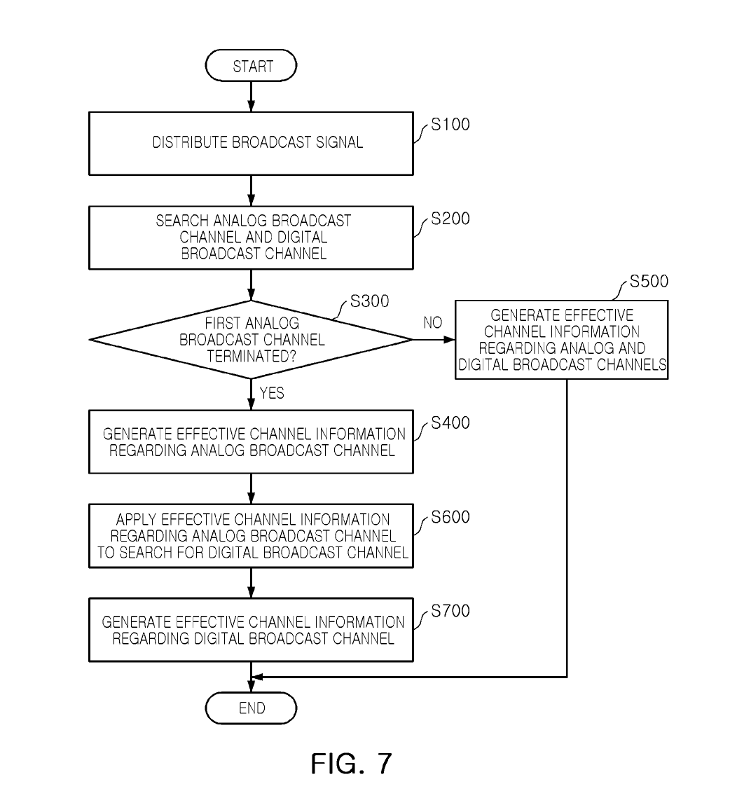

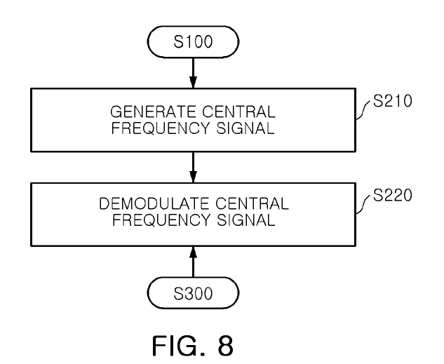

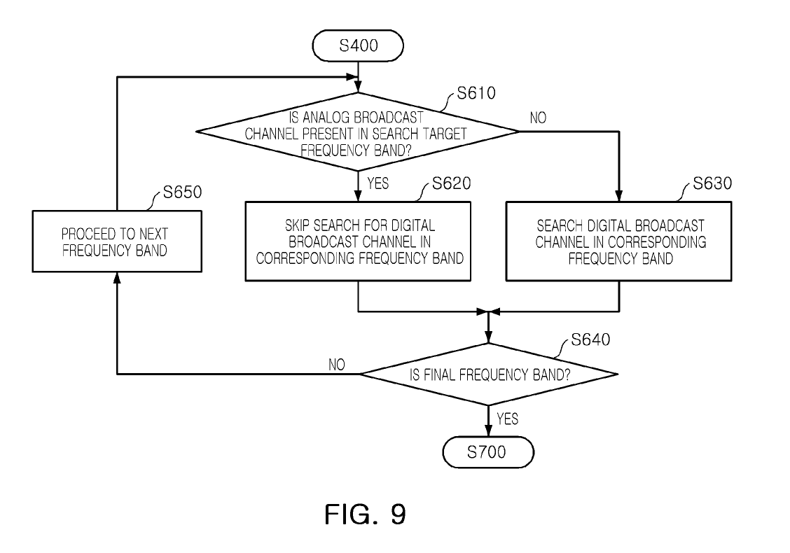

FIG. 7 is a flow chart illustrating an example of a method for searching broadcast channels according to an exemplary embodiment of the present disclosure. FIG. 8 is a flow chart illustrating an example of an operation of searching an analog broadcast channel and a digital broadcast channel of FIG. 7. FIG. 9 is a flow chart illustrating an example of an operation of applying effective channel information regarding an analog broadcast channel of FIG. 7 to the searching of the digital broadcast channel.

A method for searching broadcast channels according to an exemplary embodiment of the present disclosure may be implemented by the apparatus for searching the broadcast channels illustrated in FIGS. 1 through 4, but is not necessarily limited thereto.

Referring to FIG. 7, in the method for searching broadcast channels according to an exemplary embodiment of the present disclosure, a broadcast signal received from the antenna 10 may be first distributed to the plurality of channel searching units 510, 520, 610, and 620 (S100) and the controlling unit 400 may control the analog/digital channel searching units 510 and 520 from among the plurality of channel searching units 510, 520, 610, and 620 to search an analog broadcast channel and control the digital channel searching units 610 and 620 to search a digital broadcast channel (S200).

Here, the searching of the analog and digital broadcast channels (S200) may include generating a central frequency signal in a preset frequency band in the distributed broadcast signal (S210) and outputting channel information by demodulating the generated central frequency signal (S220), as shown in FIG. 8.

Next, when the search for the analog broadcast channel is terminated first (S300), the controlling unit 400 may generate effective channel information regarding the analog broadcast channel using the searching result of the analog broadcast channel received from the analog/digital channel searching units 510 and 520 (S400). Here, when the search for the digital broadcast channel is terminated simultaneously with the search for the analog broadcast channel, or is terminated within a preset time, the controlling unit 400 may generate the effective channel information regarding the analog and digital broadcast channels (S500).

Next, the controlling unit 400 may apply the generated effective channel information regarding the analog broadcast channel to the search for the digital broadcast channel (S600).

By way of example, as shown in FIG. 9, the controlling unit 400 may first determine whether or not the analog broadcast channel is present in the frequency band in which the search for the digital broadcast channel is performed, using the effective channel information regarding the analog broadcast channel generated in the previous operation S400 (S610). Here, when the analog broadcast channel is present, the controlling unit 400 may control the channel searching unit 510, 520, 610, or 620 searching the corresponding frequency band to skip the search for the channel in the corresponding frequency band (S620). Here, when the analog broadcast channel is not present in the corresponding frequency band, the controlling unit 400 may control the channel searching unit 510, 520, 610, or 620 searching the corresponding frequency band to search the channel in the corresponding frequency band (S630). Next, the controlling unit 400 may determine whether or not the skipped or searched frequency band is a final frequency band for the broadcast signal (S640). Here, when the frequency band is not the final frequency band, proceeding to the next frequency band is performed (S650) and the determining of whether or not the analog broadcast channel is present in the corresponding frequency band (S610) through the determining of whether or not the corresponding frequency band is the final frequency band (S640) may be repeatedly performed.

Here, when the corresponding frequency band is the final frequency band, the controlling unit 400 may generate the effective channel information regarding the digital broadcast channel (S700) and may terminate the search for the broadcast channel.

As set forth above, according to exemplary embodiments of the present disclosure, an analog broadcast channel and a digital broadcast channel are simultaneously searched using a plurality of broadcast searching units and when the search for the analog broadcast channel is terminated first, the search for the digital broadcast channel is skipped by using analog broadcast channel information, whereby a channel searching time for the broadcast channels may be reduced.

In addition, a broadcast searching unit searching the analog broadcast channel, the search for which is terminated first, may assist in the search for the digital broadcast channel, whereby the channel searching time for the broadcast channels may be further significantly reduced.

While exemplary embodiments have been shown and described above, it will be apparent to those skilled in the art that modifications and variations could be made without departing from the spirit and scope of the present disclosure as defined by the appended claims.

What is claimed is:

1. An apparatus for searching broadcast channels, the apparatus comprising:
a broadcast signal distributing unit configured to distribute a broadcast signal;
a first channel searching unit configured to search an analog broadcast channel in the distributed broadcast signal;
a second channel searching unit configured to search a digital broadcast channel in the distributed broadcast signal; and
a controlling unit configured to receive search results from the first channel searching unit and the second channel searching unit, generate effective channel information regarding the analog broadcast channel and the digital broadcast channel using the received search results, and control the second channel searching unit to skip a channel search in a frequency band in which the analog broadcast channel is present using the generated effective channel information regarding the analog broadcast channel when the search for the analog broadcast channel by the first channel searching unit is terminated first.

2. The apparatus of claim 1, wherein the first channel searching unit includes:
a tuner unit configured to generate an intermediate frequency signal for each preset frequency band in the broadcast signal, and
a demodulating unit configured to demodulate the intermediate frequency signal and outputting channel information.

3. The apparatus of claim 1, wherein the second channel searching unit includes:
a tuner unit configured to generate an intermediate frequency signal for each preset frequency band in the broadcast signal, and
a demodulating unit configured to demodulate the intermediate frequency signal and outputting channel information.

4. The apparatus of claim 1, wherein the first channel searching unit searches the analog broadcast channel or the digital broadcast channel.

5. The apparatus of claim 1, wherein the controlling unit controls the second channel searching unit to search the digital broadcast channel in the broadcast signal in a first direction, and controls the first channel searching unit to search the digital broadcast channel in the broadcast signal in a second direction when the search for the analog broadcast channel by the first channel searching unit is terminated earlier than the search for the digital broadcast channel by the second channel searching unit.

6. An apparatus for searching broadcast channels, the apparatus comprising:
a broadcast signal distributing unit configured to distribute a broadcast signal;
a plurality of analog/digital channel searching units configured to search an analog broadcast channel or a digital broadcast channel in the distributed broadcast signal;
a plurality of digital channel searching units configured to search a digital broadcast channel in the distributed broadcast signal; and
a controlling unit configured to receive search results from the analog/digital channel searching unit and the digital channel searching unit, generate effective channel information regarding the analog broadcast channel and the digital broadcast channel using the received search results, and control the digital channel searching unit to skip a channel search in a frequency band in which the analog broadcast channel is present using the generated effective channel information regarding the analog broadcast channel when the search for the analog broadcast channel by the analog/digital channel searching unit is terminated first.

7. The apparatus of claim 6, wherein the analog/digital channel searching unit includes a first analog/digital channel searching unit and a second analog/digital searching unit, and
the controlling unit controls the first analog/digital channel searching unit to search the analog broadcast channel in the broadcast signal in a first direction and controls the second analog/digital channel searching unit to search the analog broadcast channel in the broadcast signal in a second direction.

8. The apparatus of claim 6, wherein the digital channel searching unit includes a first digital channel searching unit and a second digital channel searching unit, and
the controlling unit controls the first digital channel searching unit and the second digital channel searching unit to sequentially search the digital broadcast channel in the broadcast signal in a first direction and controls the first analog/digital channel searching unit and the second analog/digital channel searching unit to sequentially search the digital broadcast channel in the broadcast signal in a second direction when the search for the analog broadcast channel by the analog/digital channel searching unit is terminated first.

9. A method for searching broadcast channels, the method comprising:
distributing a broadcast signal;
searching an analog broadcast channel and a digital broadcast channel in the distributed broadcast signal;
generating effective channel information regarding the analog broadcast channel when the search for the analog broadcast channel is terminated first;
applying the generated effective channel information regarding the analog broadcast channel to the search for the digital broadcast channel; and
generating effective channel information regarding the digital broadcast channel.

10. The method of claim 9, wherein the searching of the analog broadcast channel and the digital broadcast channel includes:
generating a central frequency signal in a preset frequency band in the distributed broadcast signal; and
demodulating the generated central frequency signal and outputting channel information.

11. The method of claim 9, wherein the applying of the generated effective channel information regarding the analog broadcast channel to the search for the digital broadcast channel includes:
determining whether or not the analog broadcast channel is present in a frequency band in which the digital broadcast channel is currently searched using the effective channel information regarding the analog broadcast channel; and
skipping the search for the digital broadcast channel in the frequency band when the analog broadcast channel is present in the frequency band.

12. The method of claim 11, wherein the applying of the generated effective channel information regarding the analog broadcast channel to the search for the digital broadcast channel includes: searching the digital broadcast channel in the frequency band when the analog broadcast channel is not present in the frequency band.

13. The method of claim 11, further comprising: when the frequency band is not a final frequency band for the broadcast signal, proceeding to the next frequency band and determining whether or not the analog broadcast channel is present therein.

14. The method of claim 12, further comprising: when the frequency band is not a final frequency band for the broadcast signal, proceeding to the next frequency band and determining whether or not the analog broadcast channel is present therein.
